(19) United States
(12) Patent Application Publication
(10) Pub. No.: US 2025/0285791 A1
(43) Pub. Date: Sep. 11, 2025

(54) COIL COMPONENT

(71) Applicant: TDK Corporation, Tokyo (JP)

(72) Inventors: Yusuke NAGAI, Tokyo (JP); Hidenobu UMEDA, Tokyo (JP); Kouichi KAKUDA, Tokyo (JP); Shinichi SATO, Tokyo (JP); Kosuke ITO, Tokyo (JP); Youhei IIDA, Tokyo (JP); Mitsuharu KOIKE, Tokyo (JP); Keito YASUDA, Tokyo (JP); Takuya MIYASHITA, Tokyo (JP)

(73) Assignee: TDK Corporation, Tokyo (JP)

(21) Appl. No.: 19/070,911

(22) Filed: Mar. 5, 2025

(30) Foreign Application Priority Data
Mar. 11, 2024 (JP) 2024-037343

(51) Int. Cl. H01F 3/08; H01F 27/28

(52) U.S. Cl. CPC H01F 3/08; H01F 27/2847

(57) ABSTRACT

A coil component 1 includes an element body and a coil, each of a plurality of coil conductors has a rectangular shape and has corner portions in a cross section orthogonal to an extending direction of the coil conductor, at least some of the plurality of coil conductors are disposed to face each other in a first direction, the element body is provided between the coil conductors adjacent to each other in the first direction when viewed from the extending direction of the coil conductor, and includes a first portion covering at least some of the corner portions of the coil conductors and a second portion around the coil conductor, and an average particle size of metal magnetic particles located in the first portion is smaller than an average particle size of metal magnetic particles located in a second portion.

### TECHNICAL FIELD

The present disclosure relates to a coil component.

### BACKGROUND

As a coil component, a coil component that includes an element body including a plurality of metal magnetic particles of a soft magnetic material and a coil disposed in the element body and including a plurality of coil conductors is known (see, for example, Japanese Unexamined Patent Publication No. 2014-139981).

### SUMMARY

In the coil component, a resistance value of the conductor is desirably lowered from the viewpoint of improving a Q value. In order to lower the resistance value of the coil conductor, a configuration is used in which the cross-sectional area of the coil conductors is increased by making the cross-sectional shape of each of the coil conductors rectangular. However, in the configuration in which the coil conductors are adjacent to each other, magnetic saturation occurs due to concentration of magnetic flux at corner portions of the coil conductors, DC bias characteristics are deteriorated, so that loss occurs.

An object of one aspect of the present disclosure is to provide a coil component capable of reducing loss.
(1) A coil component according to one aspect of the present disclosure includes: an element body formed by stacking a plurality of magnetic layers including a plurality of metal magnetic particles of a soft magnetic material; and a coil disposed in the element body and including a plurality of coil conductors, wherein each of the plurality of coil conductors has a rectangular shape and corner portions in a cross section orthogonal to an extending direction of the coil conductor,
   at least some of the plurality of coil conductors are disposed to face each other in a stacking direction of the magnetic layers, when viewed from the extending direction of the coil conductor, the element body includes: a first portion that is provided between the coil conductors adjacent to each other in the stacking direction and covers at least some of the corner portions of the coil conductor; and a second portion around the coil conductor, and an average particle size of the metal magnetic particles located in the first portion is smaller than an average particle size of the metal magnetic particles located in the second portion.

In the coil component according to one aspect of the present disclosure, the average particle size of the metal magnetic particles located in the first portion is smaller than the average particle size of the metal magnetic particles located in the second portion. As a result, in the coil component, magnetic permeability around the corner portion of the coil conductor decreases. Therefore, in the coil component, since magnetic resistance increases around the corner portion of the coil conductor, it is possible to suppress concentration of magnetic flux at the corner portion of the coil conductor, and it is possible to suppress occurrence of magnetic saturation at the corner portion. Accordingly, DC bias characteristics can be improved in the coil component. As a result, loss can be reduced in the coil component.
(2) In the coil component of (1), the element body may include a third portion, the third portion may be provided at a position facing the first portion to sandwich the coil conductor between the first portion and the third portion in the stacking direction when viewed from the extending direction of the coil conductor, and an average particle size of the metal magnetic particles located in the third portion may be smaller than the average particle size of the metal magnetic particles located in the second portion. In this configuration, the coil conductor is located between the first portion and the third portion. As a result, in the coil component, the magnetic permeability around the coil conductor decreases. Therefore, in the coil component, since the magnetic resistance increases around the coil conductor, it is possible to suppress the concentration of magnetic flux at the coil conductor and to suppress the occurrence of magnetic saturation. Accordingly, in the coil component, the DC bias characteristics can be improved, so that the loss can be further reduced.
(3) In the coil component of (1) or (2), the coil conductor may have four side surfaces, and the first portion may be provided not to cover at least a part of each of the four side surfaces. In this configuration, at least a part of a region around the coil conductor is covered with a metal magnetic material having a large average particle size, and thus, the magnetic permeability can be secured. Accordingly, in the coil component, since inductance can be secured, coil characteristics can be secured.
(4) In the coil component according to any one of (1) to (3), the first portion may be provided in a layer having a thickness in the stacking direction, and the thickness of the first portion in the stacking direction may be smaller than a thickness of the coil conductor in the stacking direction. In this configuration, since the first portion is in a layer form, the first portion is reliably provided between the coil conductors adjacent to each other. In addition, since the thickness of the first portion in the stacking direction is smaller than the thickness of the coil conductor in the stacking direction, it is possible to secure the magnetic permeability while suppressing the occurrence of magnetic saturation at the corner portion of the coil conductor. Accordingly, in the coil component, since inductance can be secured, coil characteristics can be secured.
(5) In the coil component according to any one of (1) to (4), the first portion may be provided between all the coil conductors adjacent to each other in the stacking direction. In this configuration, since the first portion is provided between all the coil conductors adjacent to each other, it is possible to suppress concentration of magnetic flux at the corner portions of all the coil conductors, and thus, it is possible to suppress occurrence of magnetic saturation at the corner portions. Accordingly, the DC bias characteristics can be further improved in the coil component.
(6) In the coil component according to any one of (1) to (5), the first portion may be provided along the corner portion of the coil conductor, and at least some of the plurality of metal magnetic particles located in the first portion may be in contact with the coil conductor. In this configuration, since no other member is provided between the first portion and the corner portion of the coil conductor, it is possible to more reliably prevent the concentration of magnetic flux at the corner portion and of the coil conductor.

According to one aspect of the present disclosure, the loss can be reduced.

### BRIEF DESCRIPTION OF THE DRAWINGS

FIG. 1 is a perspective view of a coil component according to an embodiment;

FIG. 2 is a diagram illustrating a cross-sectional configuration of the coil component illustrated in FIG. 1;

FIG. 3 is a perspective view illustrating a configuration of a coil;

FIG. 4 is a schematic enlarged view illustrating a cross-sectional configuration between coil conductors in an element body;

FIG. 5 is a schematic enlarged view illustrating a cross-sectional configuration of the coil conductor in the element body;

FIG. 6 is a diagram illustrating a cross-sectional configuration of a coil component according to still another embodiment;

FIG. 7 is a diagram illustrating a cross-sectional configuration of a coil component according to still another embodiment;

FIG. 8 is a diagram illustrating a sectional configuration of a coil component according to still another embodiment; and

FIG. 9 is a diagram illustrating a cross-sectional configuration of a coil component according to still another embodiment.

### DETAILED DESCRIPTION

Hereinafter, preferred embodiments of the present invention will be described in detail with reference to the accompanying drawings. Note that the same or corresponding elements in the description of the drawings are denoted by the same reference signs, and redundant description is omitted.

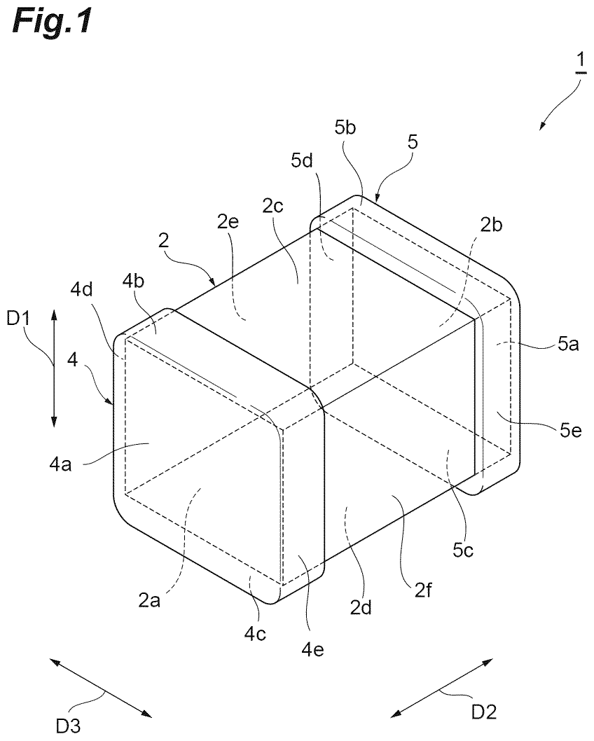

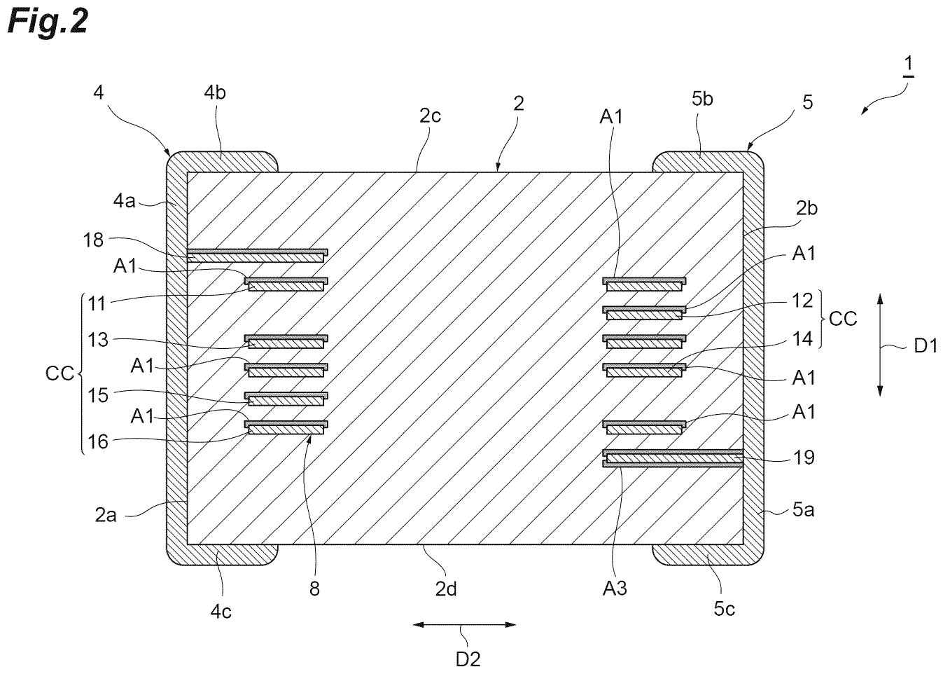

As illustrated in FIGS. 1 and 2, a coil component 1 includes an element body 2, and a terminal electrode 4 and a terminal electrode 5 disposed at both end portions of the element body 2, respectively.

The element body 2 has, for example, a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 2 has, as outer surfaces thereof, a pair of end surfaces 2a and 2b facing each other, a pair of principal surfaces 2c and 2d facing each other, and a pair of side surfaces 2e and 2f facing each other. A facing direction in which the pair of principal surfaces 2c and 2d faces each other is a first direction D1. A facing direction in which the pair of end surfaces 2a and 2b faces each other is a second direction D2. A facing direction in which the pair of side surfaces 2e and 2f faces each other is a third direction D3. In the present embodiment, the first direction D1 is a height direction of the element body 2. The second direction D2 is a longitudinal direction of the element body 2, and is orthogonal to the first direction D1. The third direction D3 is a width direction of the element body 2, and is orthogonal to the first direction D1 and the second direction D2.

The pair of end surfaces 2a and 2b extends in the first direction D1 to connect the pair of principal surfaces 2c and 2d. The pair of end surfaces 2a and 2b also extends in the third direction D3 (short side direction of the pair of principal surfaces 2c and 2d). The pair of side surfaces 2e and 2f extends in the first direction D1 to connect the pair of principal surfaces 2c and 2d. The pair of side surfaces 2e and 2f also extends in the second direction D2 (long side direction of the pair of end surfaces 2a and 2b). When the coil component 1 is implemented on another electronic device (for example, a circuit board, a multilayer electronic component, or the like), the principal surface 2d can be defined as an implementation surface facing the other electronic device.

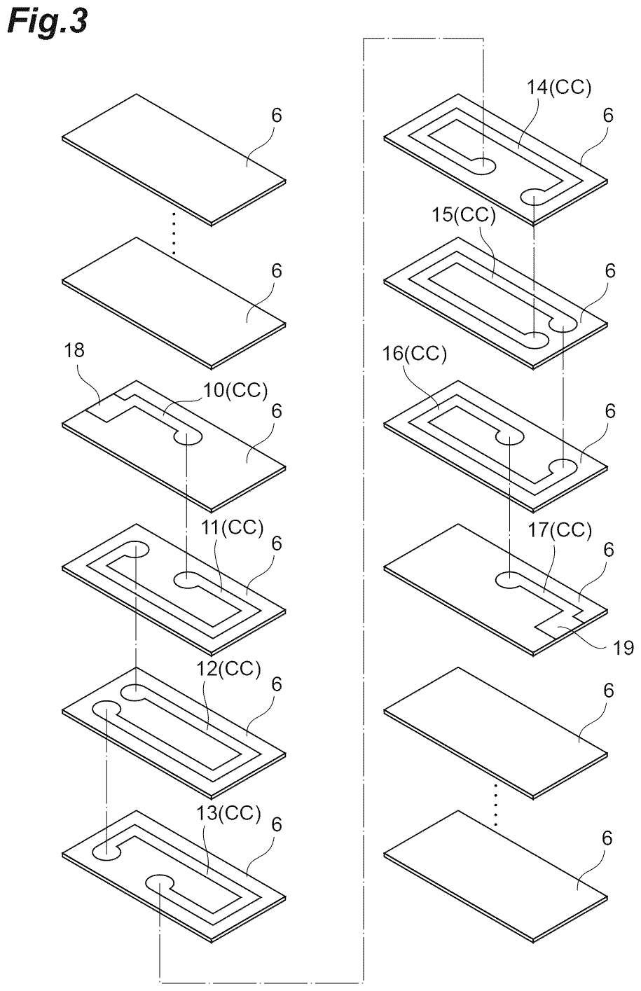

As illustrated in FIG. 3, the element body 2 is formed by stacking a plurality of magnetic layers 6. The magnetic layers 6 are stacked in the first direction D1. That is, the first direction D1 is a stacking direction. The element body 2 has the plurality of stacked magnetic layers 6. In the actual element body 2, the plurality of magnetic layers 6 are integrated to such an extent that boundaries between the layers cannot be visually recognized.

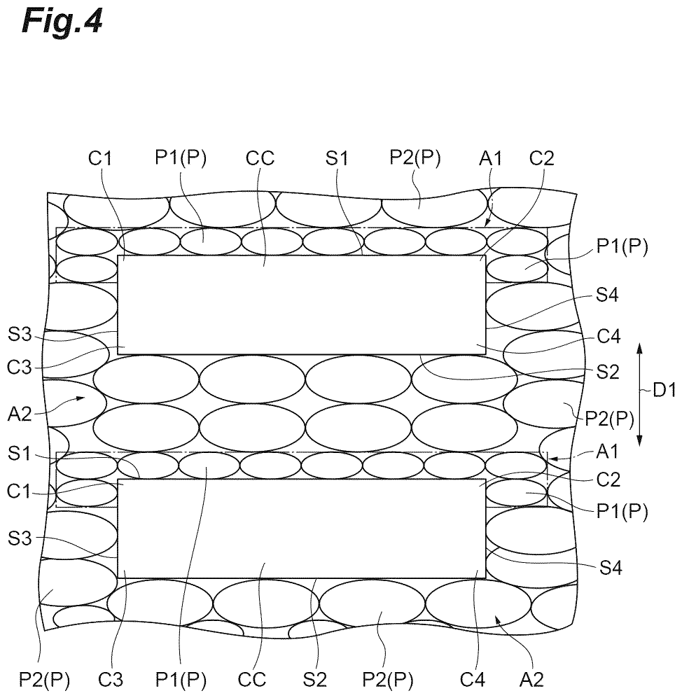

The element body 2 (magnetic layers 6) includes a plurality of metal magnetic particles P (see FIG. 4). The metal magnetic particles P are made of a soft magnetic alloy (soft magnetic material). The soft magnetic alloy is, for example, a Fe—Si-based alloy. When the soft magnetic alloy is a Fe—Si-based alloy, the soft magnetic alloy may contain P. The soft magnetic alloy may be, for example, a Fe—Ni—Si—M-based alloy. “M” contains one or more elements selected from Co, Cr, Mn, P, Ti, Zr, Hf, Nb, Ta, Mo, Mg, Ca, Sr, Ba, Zn, B, Al, and rare earth elements.

In the element body 2, the metal magnetic particles P and P are bonded to each other. The bonding between the metal magnetic particles P and P is realized by, for example, bonding between oxide films formed on surfaces of the metal magnetic particles P. The thickness of the oxide film is, for example, 5 nm or more and 60 nm or less. The oxide film may include one or a plurality of layers.

As illustrated in FIGS. 1 and 2, the terminal electrode 4 is disposed on the end surface 2a side of the element body 2, and the terminal electrode 5 is disposed on the end surface 2b side of the element body 2. That is, the terminal electrode 4 and the terminal electrode 5 are positioned apart from each other in the facing direction of the pair of end surfaces 2a and 2b. The terminal electrode 4 and the terminal electrode 5 include a conductive material (for example, Ag or Pd). The terminal electrode 4 and the terminal electrode 5 are formed as a sintered body of a conductive paste containing a conductive metal powder (for example, Ag powder or Pd powder) and glass frit. Electroplating is applied to the terminal electrode 4 and the terminal electrode 5 to form a plating layer on surfaces thereof. For example, Ni, Sn, or the like is used for electroplating.

The terminal electrode 4 is disposed on the one end surface 2a side. The terminal electrode 4 includes five electrode portions including a first electrode portion 4a positioned on the end surface 2a, a second electrode portion 4b positioned on the principal surface 2c, a third electrode portion 4c positioned on the principal surface 2d, a fourth electrode portion 4d positioned on the side surface 2e, and a fifth electrode portion 4e positioned on the side surface 2f. The first electrode portion 4a, the second electrode portion 4b, the third electrode portion 4c, the fourth electrode portion 4d, and the fifth electrode portion 4e are connected at the ridge line portion of the element body 2, and are electrically connected to each other. The terminal electrode 4 is formed on five surfaces of one end surface 2a, the pair of principal surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed.

In the present embodiment, edges of the second electrode portion 4b and the third electrode portion 4c of the terminal electrode 4 are, for example, along the third direction D3. The edge of the second electrode portion 4b is linearly formed on the principal surface 2c. The edge of the third electrode portion 4c is linearly formed on the principal surface 2d. Edges of the fourth electrode portion 4d and the fifth electrode portion 4e of the terminal electrode 4 are along the first direction D1. The edge of the fourth electrode portion 4d is linearly formed on the side surface 2e. The edge of the fifth electrode portion 4e is linearly formed on the side surface 2f. Note that, the edges of the second electrode portion 4b, the third electrode portion 4c, the fourth electrode portion 4d, and the fifth electrode portion 4e may be curved or uneven.

The terminal electrode 5 is disposed on the other end surface 2b side. The terminal electrode 5 includes five electrode portions including a first electrode portion 5a positioned on the end surface 2b, a second electrode portion 5b positioned on the principal surface 2c, a third electrode portion 5c positioned on the principal surface 2d, a fourth electrode portion 5d positioned on the side surface 2e, and a fifth electrode portion 5e positioned on the side surface 2f. The first electrode portion 5a, the second electrode portion 5b, the third electrode portion 5c, the fourth electrode portion 5d, and the fifth electrode portion 5e are connected at the ridge line portion of the element body 2, and are electrically connected to each other. The terminal electrode 5 is formed on five surfaces of one end surface 2b, the pair of principal surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed.

In the present embodiment, edges of the second electrode portion 5b and the third electrode portion 5c of the terminal electrode 5 are, for example, along the third direction D3. The edge of the second electrode portion 5b is linearly formed on the principal surface 2c. The edge of the third electrode portion 5c is linearly formed on the principal surface 2d. Edges of the fourth electrode portion 5d and the fifth electrode portion 5e of the terminal electrode 5 are along the first direction D1. The edge of the fourth electrode portion 5d is linearly formed on the side surface 2e. The edge of the fifth electrode portion 5e is linearly formed on the side surface 2f. Note that, the edges of the second electrode portion 5b, the third electrode portion 5c, the fourth electrode portion 5d, and the fifth electrode portion 5e may be curved or uneven.

As illustrated in FIG. 2, the coil component 1 includes a coil 8. The coil 8 is disposed in the element body 2. The coil 8 is formed in a spiral shape by electrically connecting a plurality of coil conductors CC to a first connection conductor 18 and a second connection conductor 19. In the present embodiment, the plurality of coil conductors CC include a plurality of coil conductors 10, 11, 12, 13, 14, 15, 16, and 17 as illustrated in FIG. 3.

The coil conductor 10 and the first connection conductor 18 are integrally formed. The coil conductor 17 and the second connection conductor 19 are integrally formed. The adjacent coil conductors CC (coil conductors 10 to 17) are electrically connected by through-hole conductors (not illustrated). The first connection conductor 18 constitutes one end portion of the coil 8. The first connection conductor 18 is exposed on the end surface 2a of the element body 2 and is connected to the terminal electrode 4 (first electrode portion 4a). The second connection conductor 19 constitutes the other end portion of the coil 8. The second connection conductor 19 is exposed on the end surface 2b of the element body 2 and is connected to the terminal electrode 5 (first electrode portion 5a).

The plurality of coil conductors CC (coil conductors 10 to 17), the first connection conductor 18, and the second connection conductor 19 are made of a conductive material usually used as a conductor of a coil. For example, Ag, Cu, Au, Al, Pd, a Pd/Ag alloy, or the like can be used as the conductive material. In the present embodiment, the conductive material is Ag. The plurality of coil conductors CC (coil conductors 10 to 17), the first connection conductor 18, and the second connection conductor 19 are plated conductors. The plurality of coil conductors CC (coil conductors 10 to 17), the first connection conductor 18, and the second connection conductor 19 may be configured as a sintered body of a conductive paste containing the conductive material.

As illustrated in FIG. 2, the plurality of coil conductors CC have portions facing each other in the first direction D1. Specifically, the coil conductor 10 and the coil conductor 11 have portions facing each other in the first direction D1. The coil conductor 11 and the coil conductor 12 have portions facing each other in the first direction D1. The coil conductor 12 and the coil conductor 13 have portions facing each other in the first direction D1. The coil conductor 13 and the coil conductor 14 have portions facing each other in the first direction D1. The coil conductor 14 and the coil conductor 15 have portions facing each other in the first direction D1. The coil conductor 15 and the coil conductor 16 have portions facing each other in the first direction D1. The coil conductor 16 and the coil conductor 17 have portions facing each other in the first direction D1.

Each of the plurality of coil conductors CC (coil conductors 10 to 17) has a rectangular shape in a cross section orthogonal to its extending direction. The rectangular shape may include not only a shape whose corner is a right angle but also a shape whose corner is curved. Each of the plurality of coil conductors CC (coil conductors 10 to 17) has corner portions C1, C2, C3, and C4 (see FIG. 4) in the cross section orthogonal to the extending direction.

FIG. 4 is a schematic enlarged view illustrating a cross-sectional configuration between the coil conductors CC in the element body 2. As illustrated in FIG. 4, the coil conductor CC has four side surfaces S1, S2, S3, and S4. The side surface S1 and the side surface S2 face each other in the first direction D1. The side surface S3 and the side surface S4 extend along the first direction D1 to straddle the side surface S1 and the side surface S2.

The coil conductor CC has the four corner portions C1, C2, C3, and C4. The corner portion C1 is formed by the side surface S1 and the side surface S3. The corner portion C2 is formed by the side surface S1 and the side surface S4. The corner portion C3 is formed by the side surface S2 and the side surface S3. The corner portion C4 is formed by the side surface S2 and the side surface S4.

As illustrated in FIG. 2, 4, or 5, the element body 2 includes a first portion A1, a second portion A2, and a third portion A3. The first portion A1 is provided between the coil conductors CC adjacent to each other in the first direction D1 when viewed from the extending direction of the coil conductor CC (the third direction D3 in the example illustrated in FIG. 2), and covers the corner portions C1 and C2 of the coil conductor CC. In the example illustrated in FIG. 2, the first portion A1 is provided to also cover the first connection conductor 18 and the second connection conductor 19.

As illustrated in FIG. 4, the first portion A1 is provided to cover the side surface S1, the corner portion C1, and the corner portion C2. The first portion A1 is provided to cover the side surface S1, a part of the side surface S3, and a part of the side surface S4. The first portion A1 is provided along the coil conductor CC. At least some of a plurality of metal magnetic particles P1 located in the first portion A1 are in contact with the coil conductor CC. That is, no other member is provided between the coil conductor CC and the first portion Al. The plurality of metal magnetic particles P1 are disposed in the first portion A1. The first portion A1 includes the plurality of metal magnetic particles P1.

The second portion A2 is a portion around the coil conductor CC (a portion other than the first portion A1 and the third portion A3). A plurality of metal magnetic particles P2 are disposed in the second portion A2. The second portion A2 includes the plurality of metal magnetic particles P2.

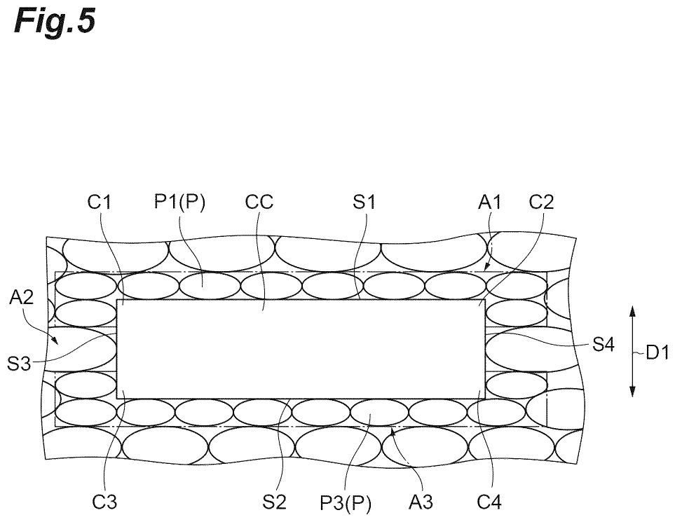

As illustrated in FIGS. 2 and 5, the third portion A3 is provided at a position sandwiching the coil conductor CC with the first portion A1 in the first direction D1 when viewed from the extending direction of the coil conductor CC. The first portion A1 and the third portion A3 are provided at positions sandwiching the coil conductor CC. In other words, the coil conductor CC is located between the first portion Al and the third portion A3. A plurality of metal magnetic particles P3 are disposed in the third portion A3. The third portion A3 includes the plurality of metal magnetic particles P3.

An average particle size of the metal magnetic particles P1 located in the first portion A1 is smaller than an average particle size of the metal magnetic particles P2 located in the second portion A2. An average particle size of the metal magnetic particles P3 located in the third portion A3 is smaller than the average particle size of the metal magnetic particles P2 located in the second portion A2. The average particle size of the metal magnetic particles P3 may be equal to the average particle size of the metal magnetic particles P1 or larger than the average particle size of the metal magnetic particles P1. In the present embodiment, a particle size is defined by an equivalent circle diameter. Equivalent circle diameters of the metal magnetic particles P1, P2, and P3 are obtained, for example, as follows.

A cross-sectional photograph of the coil component 1 is acquired. The acquired cross-sectional photograph is subjected to image processing by software. The boundary of the metal magnetic particles P1, P2, and P3 is determined by image processing, and the area of the metal magnetic particles P1, P2, and P3 is obtained. From the obtained area of the metal magnetic particles P1, P2, and P3, particle sizes converted into the equivalent circle diameters are obtained. Here, the particle sizes of 100 or more metal magnetic particles P1, P2, and P3 are calculated, and the particle size distribution of these metal magnetic particles P1, P2, and P3 is obtained. A particle size (d50) at an integrated value of 50% in the obtained particle size distribution is taken as “average particle size”. Particle shapes of the metal magnetic particles P1, P2, and P3 are not particularly limited.

As described above, the average particle size of the metal magnetic particles P1 located in the first portion A1 is smaller than the average particle size of the metal magnetic particles P2 located in the second portion A2 in the coil component 1 according to the present embodiment. As a result, in the coil component 1, the magnetic permeability around the corner portions C1 and C2 of the coil conductor CC decreases. Therefore, in the coil component 1, since magnetic resistance increases around the corner portions C1 and C2 of the coil conductor CC, it is possible to suppress the concentration of the magnetic flux at the corner portions C1 and C2 of the coil conductor CC and to suppress the occurrence of magnetic saturation at the corner portions C1 and C2. Accordingly, in the coil component 1, the DC bias characteristics can be improved. As a result, loss can be reduced in the coil component.

In the coil component 1 according to the present embodiment, the element body 2 includes the third portion A3 provided at the position sandwiching the coil conductor CC with the first portion A1 in the first direction D1 when viewed from the extending direction of the coil conductor CC. In the coil component 1, the average particle size of the metal magnetic particles P3 located in the third portion A3 is smaller than the average particle size of the metal magnetic particles P2 located in the second portion A2. In this configuration, the coil conductor CC is located between the first portion Al and the third portion A3. As a result, the magnetic permeability around the coil conductor CC decreases in the coil component 1. Therefore, in the coil component 1, since the magnetic resistance increases around the coil conductor CC, it is possible to suppress the concentration of magnetic flux at the coil conductor CC and to suppress the occurrence of magnetic saturation. Accordingly, in the coil component 1, the DC bias characteristics can be improved, so that the loss can be further reduced.

In the coil component 1 according to the present embodiment, the first portion A1 is provided between all the coil conductors CC adjacent to each other in the first direction D1. In this configuration, since the first portion A1 is provided between all the coil conductors CC adjacent to each other, it is possible to suppress the concentration of magnetic flux at the corner portions C1 and C2 of target coil conductors CC, and thus, it is possible to suppress the occurrence of magnetic saturation at the corner portions C1 and C2. Accordingly, the DC bias characteristics can be further improved in the coil component 1.

In the coil component 1 according to the present embodiment, the first portion A1 is provided along the corner portions C1 and C2 of the coil conductor CC. At least some of a plurality of metal magnetic particles P1 located in the first portion A1 are in contact with the coil conductor CC. In this configuration, since no other member is provided between the first portion A1 and the corner portions C1 and C2 of the coil conductor CC, it is possible to more reliably prevent the concentration of magnetic flux at the corner portions C1 and C2 of the coil conductor CC.

Although the embodiments of the present disclosure have been described in the foregoing, the present disclosure is not necessarily limited to the above-described embodiments, and various modifications can be made without departing from the gist thereof.

In the above embodiment, a mode in which the first portion A1 covers the corner portions C1 and C2 and the side surface S1 of the coil conductor CC has been described as an example. However, it is sufficient that the first portion A1 covers a part of each of the corner portions C1 and C2 of the coil conductor CC.

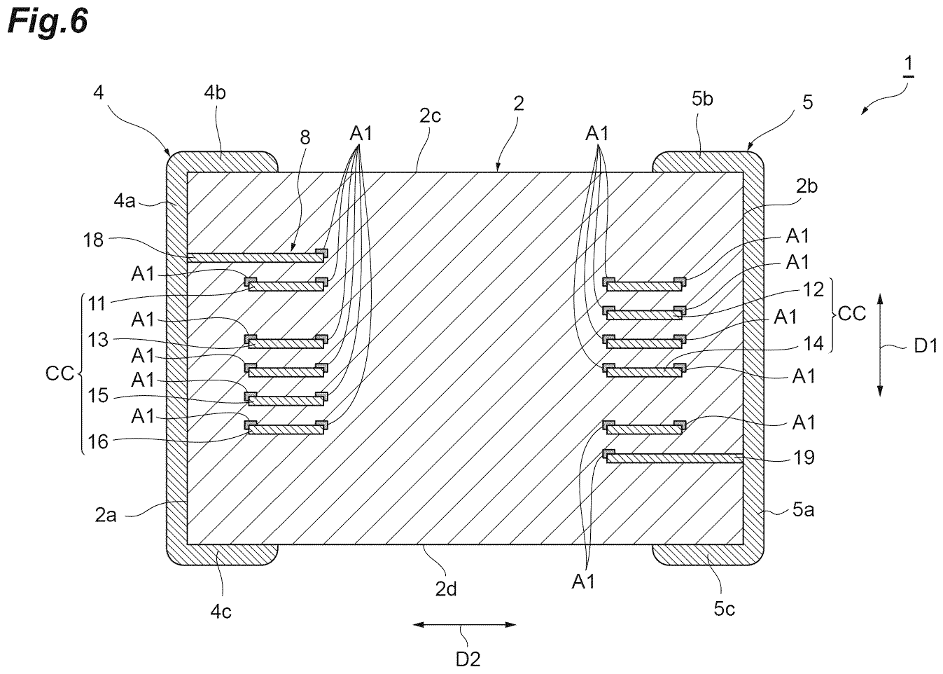

As illustrated in FIG. 6, the first portion A1 is provided to cover the corner portion C1 and the corner portion C2 of the coil conductor CC. That is, the first portion A1 is not provided to cover the side surface S1 of the coil conductor CC in the example illustrated in FIG. 5.

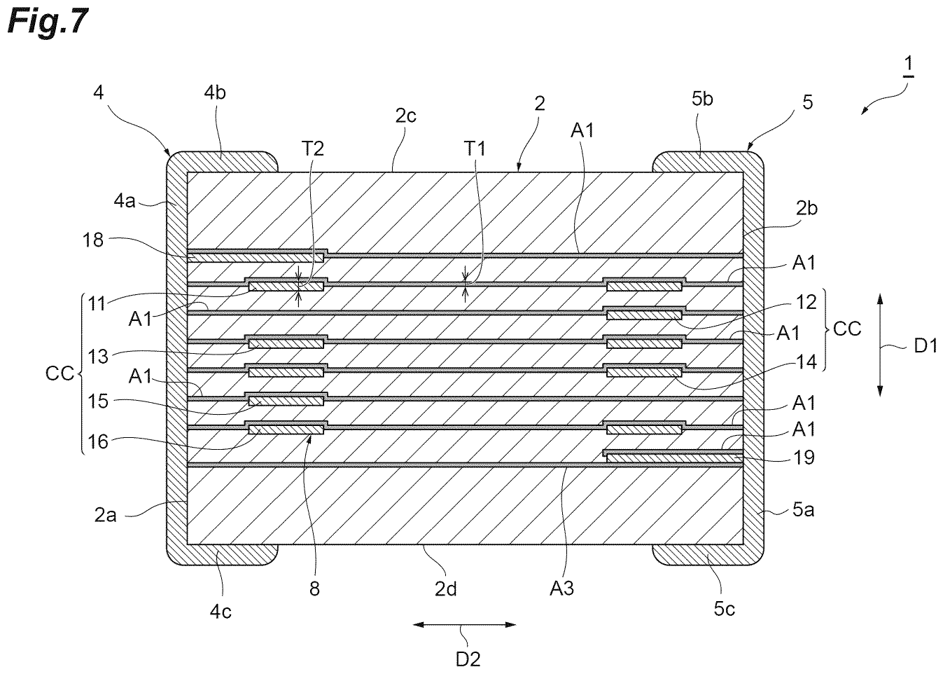

As illustrated in FIG. 7, the first portion A1 may be provided in a layer having a thickness in the first direction D1. In this configuration, since the first portion A1 is in a layer form, the first portion A1 is reliably provided between the coil conductors CC adjacent to each other. The third portion A3 may also be provided in a layer form. A thickness T1 of the first portion A1 in the first direction D1 is smaller than a thickness T2 of the coil conductor CC in the first direction D1 (T1<T2). In this configuration, it is possible to secure the magnetic permeability while suppressing the occurrence of magnetic saturation at the corner portions C1 and C2 of the coil conductor CC. Accordingly, in the coil component 1, since inductance can be secured, coil characteristics can be secured.

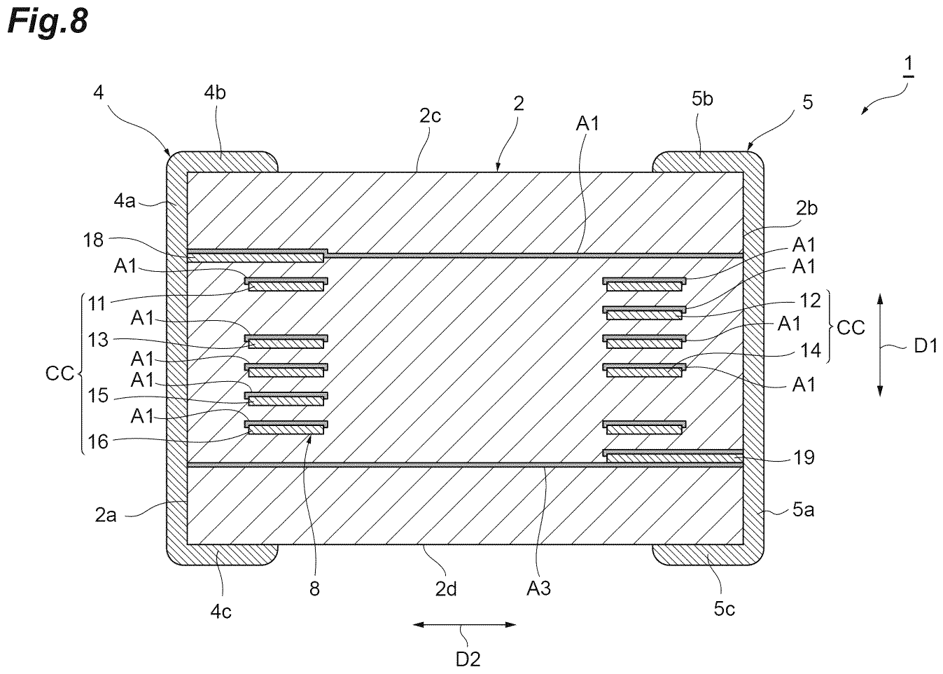

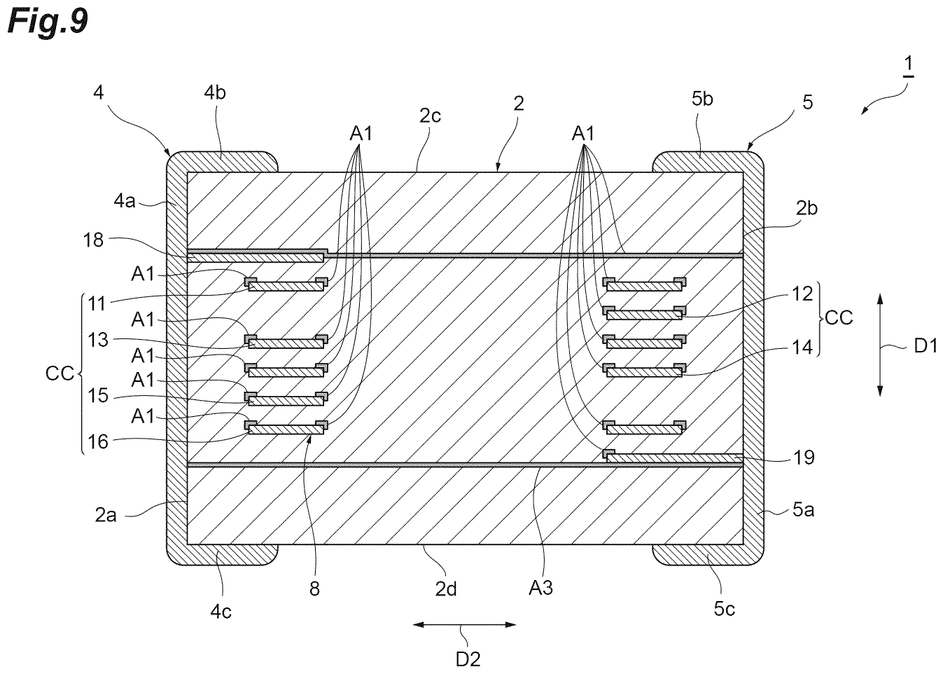

As illustrated in FIG. 8, the first portion A1 in a layer form may be provided in a part of the coil component 1. As illustrated in FIG. 9, the first portion A1 covers only a part of each of the corner portions C1 and C2 of the coil conductor CC, and the first portion A1 may be provided in a part of the coil component 1.

In the above embodiments, a mode in which the conductive material forming the coil conductor CC or the like is Ag has been described as an example. However, the coil conductor CC may be a plated conductor.

In the above embodiment, a mode in which the terminal electrode 4 includes the first electrode portion 4a, the second electrode portion 4b, the third electrode portion 4c, the fourth electrode portion 4d, and the fifth electrode portion 4e, and the terminal electrode 5 includes the first electrode portion 5a, the second electrode portion 5b, the third electrode portion 5c, the fourth electrode portion 5d, and the fifth electrode portion 5e has been described as an example. However, the shape of the terminal electrode is not limited thereto. For example, the terminal electrode may be disposed only on the principal surface 2d (bottom surface terminal type), or may be disposed over the end surfaces 2a and 2b and the principal surface 2d (L-shaped terminal type).

What is claimed is:

1. A coil component comprising:
an element body formed by stacking a plurality of magnetic layers including a plurality of metal magnetic particles of a soft magnetic material; and
a coil disposed in the element body and including a plurality of coil conductors,
wherein each of the plurality of coil conductors has a rectangular shape and corner portions in a cross section orthogonal to an extending direction of the coil conductor,
at least some of the plurality of coil conductors are disposed to face each other in a stacking direction of the magnetic layers,
when viewed from the extending direction of the coil conductor, the element body includes:
a first portion that is provided between the coil conductors adjacent to each other in the stacking direction and covers at least some of the corner portions of the coil conductor; and
a second portion around the coil conductor, and
an average particle size of the metal magnetic particles located in the first portion is smaller than an average particle size of the metal magnetic particles located in the second portion.

2. The coil component according to claim 1, wherein
the element body includes a third portion,
the third portion is provided at a position facing the first portion to sandwich the coil conductor between the first portion and the third portion in the stacking direction when viewed from the extending direction of the coil conductor, and
an average particle size of the metal magnetic particles located in the third portion is smaller than the average particle size of the metal magnetic particles located in the second portion.

3. The coil component according to claim 1, wherein
the coil conductor has four side surfaces, and
the first portion is provided not to cover at least a part of each of the four side surfaces.

4. The coil component according to claim 1, wherein
the first portion is provided in a layer having a thickness in the stacking direction, and
the thickness of the first portion in the stacking direction is smaller than a thickness of the coil conductor in the stacking direction.

5. The coil component according to claim 1, wherein the first portion is provided between all the coil conductors adjacent to each other in the stacking direction.

6. The coil component according to claim 1, wherein
the first portion is provided along the corner portions of the coil conductor, and
at least some of the plurality of metal magnetic particles located in the first portion are in contact with the coil conductor.
